(19) United States
(12) Patent Application Publication
(10) Pub. No.: US 2002/0129005 A1
(43) Pub. Date: Sep. 12, 2002

(54) Method and apparatus for regrouping data

(75) Inventor: Eetu Ojanen, Jyvaskyla (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Republica Jyvaskyla OY

(21) Appl. No.: 10/053,884

(22) Filed: Jan. 22, 2002

(30) Foreign Application Priority Data
Jan. 23, 2001 (FI) 20010136

(51) Int. Cl. G06F 7/00

(52) U.S. Cl. 707/1

(57) ABSTRACT

The invention relates to a method for generating rules, by which method data can be regrouped. In addition, the invention relates to an arrangement for realizing said method. The object of the invention is to realize a method and arrangement whereby even a user without any skills in program-writing can generate extraction rules for data areas chosen from the source data. In said method, the information contained in the original data is treated so that from the original source data, the user selects at least two exemplary cases. On the basis of the exemplary cases pointed out, there is generated a set of rules, and the data areas according to said rules are extracted from the original source data. The extracted data areas can be further processed in a desired way.

### TECHNICAL FIELD

The invention relates to a method for creating rules, by means of which rules information can be regrouped. In addition, the invention relates to an arrangement for producing such a method.

### BACKGROUND OF THE INVENTION

The quantity of available information is immense, because there are several powerful devices for collecting electronic data, and the general storing capacity has increased. Electronic data is easily accessed, but the finding of essential information is more difficult. There are techniques for anticipating and evaluating the contents of the data. Generally people try to find valid, new, feasible and understandable information. Problems arise, for instance if the data is incomplete or non-uniform. Data may also be temporary or changing, there may be an overwhelming amount of data for processing, or part of the data can be expressed in other than text form. Among this extensive amount of data, there should be found a specific piece of information connected for example to a certain enterprise or a certain problem.

It must also be possible to combine and compare information found at various different sources. In order to be able to analyze non-uniform information, the information must be rendered in a uniform format. Moreover, both in the internal data traffic and exchange of an enterprise as well as in the data traffic and exchange between enterprises, there is required a certain level of uniform qualities. At present, personality is an important way to be distinguished in the market. However, personal solutions deviate from the so-called standard solutions and consequently make further data processing more difficult. This means that documents should be presented in a flexible way, so that they are suited and can be combined to as many other applications as possible. In general, a single personal solution requires effective hardware to take care of the connections. The hardware and software provided for realizing the connections must be easy to use, and they must be able to grow along with the enterprise. The maintenance and programming of this type of hardware and software combination, with respect to all necessary standards and requirements, is a very demanding task.

There are solutions that standardize various file formats to one and the same, processable form. For instance XWrap Elite (an eXtensible Wrapper Generation System Elite Version) is a software application that tries to identify repeated data structures in HTML documents and to create specific modification rules, whereby their contents can be translated to the XML language. However, the operation of the application is bound to the HTML structure. Before the priority date of the present application, the XWrap Elite-program has been described in more detail at the address http://www.cc.gatech.edu/projects/disl/XWRAPElite/. Another corresponding solution based on the HTML structure is the W4F—World Wide Web Wrapper Factory, which before the priority date of the present application is described in more detail at the address http://www.tropea-inc.com/technology/W4F/. After the priority date of the present application corresponding information has been made available at another network address, which is http://citeseer.nj.nec.com/did/95215. In addition, the Xerox Research Center Europe has a system that was made public in the spring of 2000 for generating data translation scripts, called Wrapper Generation via Grammar Induction; also this system is bound to the HTML format. Already before the priority date of the present application, said system was published at the addresses http://turing.wins.uva.nl/˜ragetli/documents/chidlovskii.ps and http://turing.wins.uva.nl/˜ragetli/ecm12000/ecm100a/. All of these existing solutions are based on the HTML format, wherefore their area of usage is fairly limited. There also is a patent related to this subject, i.e. U.S. Pat. No. 6,151,608 that describes how data is modified to a database table without writing code.

### SUMMARY OF THE INVENTION

The object of the present invention is to realize a method and arrangement whereby even a user who is not skilled to write programs can create extraction rules for certain data areas selected from any electronic data stream. By means of said rules, data areas are searched and extracted from the source data.

The object is realized step by step by means of a learning code generation application.

According to the invention, the user may extract, without writing code, selected data areas from the source data for further processing.

A code generation application may use any browser for presenting data and for making selections from the data stream. The term ‘browser’ here refers to a means for observing information, so that said information can be subjected to various selections. If the browser in question is for instance a HTML browser or a text browser, a uniform, continuous area can be selected conventionally by “painting with the mouse”. The user operates in an environment that is natural for the browser and does not necessarily need the source code generated by the code generation application and required for extracting the data. The user has at his disposal data that he wants to analyze at certain parts and/or render in a uniform format. Now the user only needs to point out to the code generation program two or more examples from the desired source data. The examples can also be pointed out from different bodies of source data.

The user gives the program exemplary cases, on the basis of which the program can extract certain structural parts from the source data. From the source data, the user points out to the code generation program certain parts, and the program generates a set of rules according to the model obtained thereby. On the basis of the generated set of rules, the code generation program searches and extracts information from the source data. Thereafter the user may for instance transform non-uniform data into one and the same format. In content, the examples given by the user should be mutually as different instances as possible of a same type of data structure that can be identified. They can be for instance rows in a table, sub-articles in a list or forms to be filled in.

Consequently, from the whole electronic flow of information, the user chooses the desired data sources and points them out as input for the code generation program. As a result, the user obtains the data based on the sources in organized form together with a generated set of extraction rules. The resulting data can also be presented in a desired format, which the user can either define himself or choose among predetermined exemplary definitions. Moreover, the program displays the chosen features so that they can be easily observed.

### BRIEF DESCRIPTION OF THE DRAWINGS

The invention is explained in more detail below, with reference to an exemplary preferred embodiment and the appended drawings, where

FIG. 1 illustrates the basic principle of the invention,

FIG. 2 illustrates how a data conversion script according to a preferred embodiment is created, and

FIG. 3 illustrates how tokenized examples are processed according to a preferred embodiment.

### DETAILED DESCRIPTION OF THE INVENTION

It is often necessary to standardize scattered documents and files that are in different formats in order to be able to further process them. Ability to standardize is an important advantage when dealing with matters between separate enterprises, because in practice it is impossible to presuppose that all enterprises with mutual cooperation or with various client relationships should standardize their data systems and programs. In data processing, the ability to standardize facilitates not only the internal data processing of the enterprise, but especially the operation of the publishing and cooperation networks. It is essential to be able to select, among the electronic flow of information, those areas that are individually important, and to be able to observe, compare and further process said parts as a uniform entity.

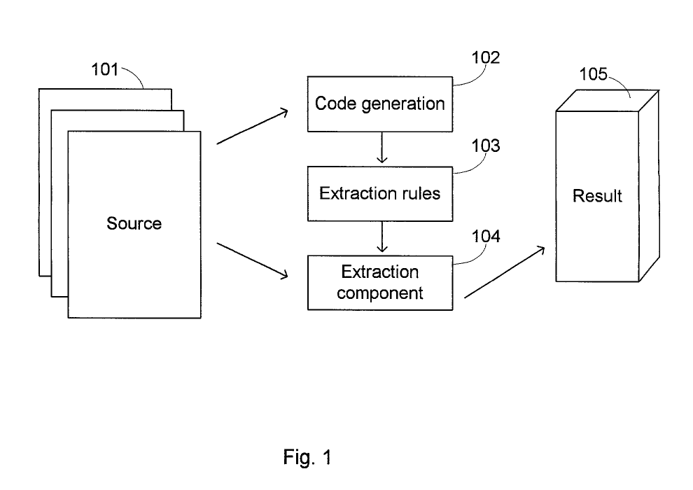

FIG. 1 illustrates the basic principles of the invention. The code generation application is a tool arranged for separating, organizing and standardizing data. The code generation application comprises three parts: a code generation component 102, the generated extraction rules 103 and an extraction component 104. The source material 101 can be any IT-material, such as files, documents or continuous data stream. The only requirement for the source format is that immediately before or after the desired data field that should be extracted there must be provided a field separator having the length of one basic unit of the data to be processed, i.e. one token, and that said field separator is repeated in all data records immediately before said data field or immediately thereafter. However, the extracted record itself may contain various different field separators. The user selects either the whole source material or certain parts, i.e. data areas, therein. The data structure of the selected data areas must be processable as flat, i.e. it must not contain recursive structures. For instance a table or a list has this kind of flat data structure. If the user wishes to treat only a part of the structural data unit, for example a table, he must point out, as examples to the code generation component 102 of the code generation application, at least two such rows in the table that are mutually as different as possible. The more the examples differ from each other, the fewer examples there are needed in order to achieve the desired extraction result. This means that as many columns as possible in the chosen exemplary rows should contain different information.

The component 103 that generates the extraction rules of the code generation application creates, on the basis of the examples, a set of rules, and on the basis of said rules, the extraction component 104 searches and extracts desired data areas from the source material 101. The extraction component 104 proper can be any suitable component. The data areas obtained as a result from the extraction process can be further processed in a desired way, for instance stored. If the data is stored in a given single location, the user obtains a document 105 that can in practice represent any possible form, depending on the user's choices and on the original source data. The original document remains intact. The generated result contains the data areas according to the examples fed in by the user, for instance all rows of a table, in a form and order defined by the user. The user can himself define for example the target format by means of a few parameters, or he can choose among ready-made, existing formats. If the user chooses a ready-made format, the format is defined by means of predetermined parameters. For the target data to be obtained, the user may also define the order of the fields and/or leave the desired data fields completely out.

That part of the source data that is chosen to be converted is called a data area. Typically a data area is a unit within which only one data structure is repeated. A data area can be for example a table, which thus contains the rows repeated in the table. A data area can also be a chapter in a text, a headline or a list. Data areas can be mutually completely different, but within each data area, there is repeated one regular data structure. This repeated data structure can be easily pointed out to the code generation application and further found by the code generation application and extracted from the source data. In a table this kind of repeating feature could be for instance the fact that the data contents are organized in rows and/or columns. As regards chapters in a text, they are generally separated by empty spaces at the beginning and at the end, prior to the beginning of the next element. A headline is provided with certain known and identifiable features, such as bold type and/or location of the text. A list usually includes an identification symbol, for instance a dash or a box, prior to the factual contents, and a line return thereafter. Thus it is essential that there is a common data structure for certain elements, and that the code generation application finds this data structure on the basis of the examples given by the user.

Data areas can also be divided into units on the basis of their contents. These units with varying or standard lengths are called tokens. The method by which character strings are divided into units on the basis of their contents is called tokenizing. One token contains type characteristics, i.e. a name and the data contents proper. As a default value, a token, i.e. a processing unit, is understood as a single symbol in a system of characters, such as a letter, number or a punctuation mark. However, it is often preferable to define tokens so that one token contains a given character string that is repeated in the data. Thus, different token types are generalizations of a sort. For instance tokens representing the type “number” are all numbers, if the regular expression of the token type is “[0-9]”, and if the regular expression of a “word” type token is “[A-Za-z]+”, the token may contain one or several successive characters within the range A-Z or a-z. Further, it is possible to define that for example only and exclusively the character string “B2B” is a token of the type “test2”. Tokenized character strings are easier to manage than single symbols.

Tokenizing makes data processing easier and faster. Owing to the applied tokenizing, the application in question is not bound to any given format, but it suffices that before or after the data field chosen to be extracted, there is provided a field separator of the length of at least one token. Thus tokenizing makes the use of the code generation application both more versatile and more rapid, because even a minimal basic knowledge of the format to be processed, when written as a tokenizing definition, makes it possible to achieve better extraction rules with a smaller amount of examples. Respectively, the use of erroneous tokenizing may lead to a situation where the algorithm cannot generate any feasible extraction rules at all. By tokenizing the data and by thereafter subjecting the tokenized data to all necessary procedures, a correct operation of the code generation application can be ensured. By utilizing tokenizing, there also is achieved an accuracy that is in each case suitable for observing the source data. In the present invention, tokenizing is a tool for generating extraction rules, but the data extraction component that interprets the rules does not know anything about tokenizing and does not use it at all.

The user points out the examples to the code generation application. Here the pointing out of examples means that the user points out the examples in the existing data and/or generates the examples himself and/or edits existing exemplary cases in order to emphasize their identical elements.

The examples given by the user to the code generation application should, as regards their non-uniform parts, be as different in content as possible, in order to make the code generation application unambiguously find the uniform elements of the exemplary cases, which uniform elements it then uses when generating the set of data extraction rules. The examples must be as different as possible in content, and therefore the use of certain types of data sources is ensured by means of tokenizing. For instance a HTML file can be divided into tags and text elements provided in between said tags. If the HTML format should be processed without tokenizing, i.e. as a default, one symbol should constitute one token, it would be very troublesome, if not impossible, to point out the examples to the code generation application. The user would spend an excessive amount of time in finding suitable examples, because on the symbol level, the contents of said examples should be completely different. Consequently, in order to define the exemplary information, there would be needed a huge amount of examples, or then the quality of the examples should be essentially improved. This improvement of the quality is carried out explicitly by tokenizing: when data in the HTML format is tokenized into tags and character strings therebetween, a difference of even one single symbol within the character strings suffices to inform the code generation application that said range should be extracted and kept uniform.

In this text, a single character in a character system is referred to as a ‘symbol’. However, a succession of several symbols is referred to as a ‘character string’. Said beginning and end symbols of the data areas to be extracted are not single characters, but character strings or regular expressions. Even the wildcard symbol (*) is not necessarily one single character, but it may correspond to a whole character string (for example .*), depending on the system, programming language and application.

The user of the code generation application may, when he so desires, himself define the tokenizing rules. Generally the tokenizing rules are chosen among predetermined settings, one example of which is the system of tags and character strings therebetween that is suitable for the HTML language. The user may also edit the predetermined tokenizing rules.

As an example of the difference of the exemplary cases, let us observe a situation with four different exemplary cases, where each of the cases consists of three successive fields. The fact that each of the exemplary cases includes three fields means that the exemplary cases have an identical structure. The difference in content means that when all first (or second or third) fields of the exemplary cases are observed together, said fields are not identical in all exemplary cases. However, it is allowed that for instance the first field of the first exemplary case is identical with the first field of the second and third exemplary case, as far as the first field of the fourth exemplary case is different in content.

The code generation application records the examples fed in by the user, and consequently examples can be added one by one, by selecting from several different sources. Typically also the extraction rules are recorded, and thus the same recorded rules can be used later on, without having to regenerate them.

The example chosen by the user from the source data is a character string. Before or after this character string to be extracted, there must be inserted a field separator of a length of at least one token, and said field separator must be repeated in identical form in all records. Inside a record, however, all field separators need not be identical. The fields to be extracted on the basis of the data structure are located and identified, i.e. the fields are given running numbers. The borders of the data fields are defined according to the tokenizing system applied in each case. On the basis of the examples given by the user, the code generation application generates an edit script. In the edit script, there are enlisted the changes by which the content of the first supplied exemplary case is made similar as the content of the second exemplary case. The basic unit repeated in the edit script is the edit information. Said edit information contains index pointers to both character strings as well as the replaced and replacing information as a whole. By focusing the changes in the edit scripts in a certain way in the longest supplied exemplary expression, which is called a regular expression, there is created, by means of the obtained regular expression, an extraction script, which then searches from the source data a character string on the basis of the supplied data. Further, the given selected data areas according to the extraction script are extracted from the source data for further processing.

Although the examples for the code generation application should be pointed out in files, the data extraction proper according to the generated rules can be carried out, apart from files, also for example from a continuous, unending data stream or a data stream with an unknown length. Thus the length of the extracted data area is only known when a predetermined end symbol is found in the data stream or in a separate control stream.

When the user has selected the exemplary cases, he may test the operation of the extraction rules of a single data area in a preview mode in the browser of the code generation application. If the user detects that there is some extra data preceding the data area that he has selected as an example, he may define the start and end symbols of the data area, or he may try and specify the existing symbols. The user must select the character string preceding the desired data area to be extracted, so that it is as unambiguous and accurate as possible in order to inform the application that it is exactly the data following this specified character string that should be extracted from the source data. Thus the user can in the preview mode check that information corresponding to the type of the chosen exemplary cases is extracted from the right areas. Respectively, the operation of the application as regards the end symbol of the data area can be ensured in similar fashion.

The examples can also be fed in as completely separate, even directly from the keyboard. Examples that were once pointed out can be changed: if the user finds out, after testing, that there was not enough difference in content between two examples, he may increase the differences by adding at least in one of the examples some symbols that do not exist in the other example.

It depends on the properties of the browser of the code generation application, whether the character strings describing the start and end symbols of the data area are directly visible for the user in the source data, and/or is the area therebetween highlighted, so that it is clearly visible. The purpose is that from the very beginning of the source data, the first detected character string signaling the beginning is the point preceding the desired data area to be extracted. Starting from the start symbol, the source data is scanned in order to find the end symbol, where the data area to be extracted ends. If the start or end symbol of the data area is missing, i.e. is empty, the code generation application interprets the beginning of the extracted data area to be the beginning of the source data, and respectively the end of the extracted data area to be the end of the source data. Thus there always is a definition for the data area, and it is not in any way dependent on the format, structure or content of the source data. The user may also edit the program-language code of the data extraction rules, if for instance a sufficient amount of suitable examples cannot be found.

If the user wants to obtain the end result in a uniform format, he may define the target format by a few parameters, or choose a predetermined format, for instance an XHTML table, as the basis of the information. When the user so desires, he may thus define in what form and provided with what extra markings the extracted records are written in the target. If the target data to be obtained as a result should be processed for example in an XML browser, the tags surrounding a given section extracted from the source data can be predetermined in order to immediately render the target data in a more illustrative and easily processed format. The examples below include tags in the XML format, and between the tags there is provided that section of the source data that is surrounded by said tags:

<datastream>the complete source data</datastream>

<dataarea>data area</dataarea>

<record>record</record>

<field>field</field>

<address>field</address>

<price>field</price>.

Hence, data area means for example tables, each of which contains one or more records, i.e. rows in a table, and each of said rows further contains one or several fields, i.e. cells/columns in the table rows.

The invention as such does not presuppose that the extracted records are stored in a given target in a uniform format. When the data is extracted from the source, it can be processed further in many different ways. As examples of possible further processing, let us mention the following: giving the extracted data to another program component or device, sending the extracted data further for example along a network connection, and partial or complete destruction of the extracted data. The extracted data areas and/or parts thereof (records, fields) can after extraction be rearranged in various different orders either prior to further processing or as part of their further processing.

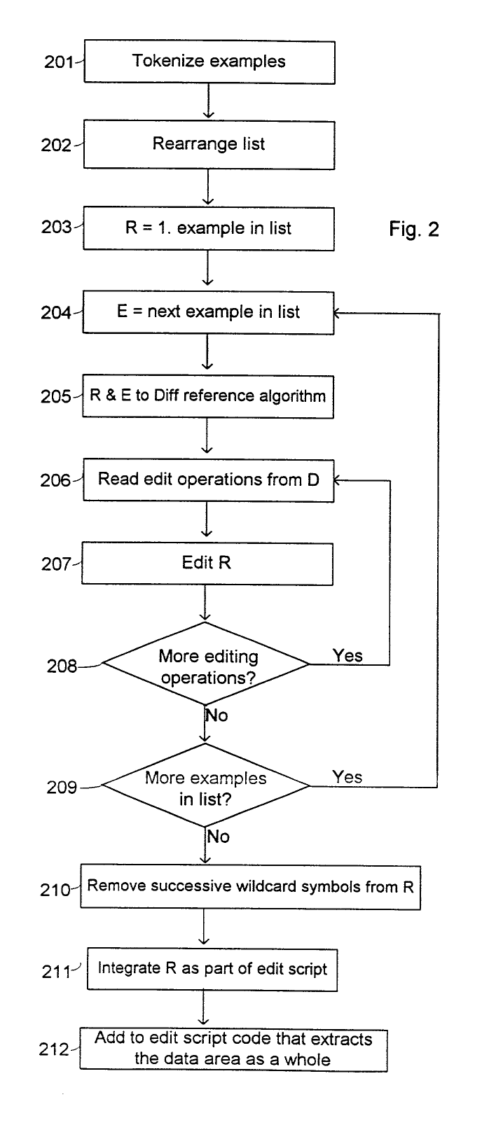

Let us observe in more detail, with reference to FIG. 2, how the code generation application functions and how the data conversion script is generated as regards one single data area. To the code generation application, there is pointed as input a list of data area definitions, each of which contains at least two examples and a character string or a regular expression in order to detect the point where the chosen data area begins and ends. Separate start or end symbols need not be inserted in the data structure examples. First, in step 201, all examples included in the example list fed in by the user are tokenized. The algorithm illustrated in the drawing does not need definitions for the beginnings and ends of the data areas, but it simply adds the obtained, ready-made information required for marking the data areas in the extraction script.

Next, step 202, the examples are arranged in a descending order of length according to the number of tokens contained therein. At step 203, the first and consequently longest example in the list is copied, and it is defined as a regular expression R. Thereafter, step 204, the next exemplary expression in the list is processed. The next, second longest expression is marked as exemplary expression E. At step 205, the regular expression R is compared with the exemplary expression E by applying a known Diff reference algorithm; before the priority date of the present application, a more detailed description of said Diff reference algorithm is found at the address http://www.cs.arizona.edu/people/gene/PAPERS/diff.ps. This reference algorithm returns the shortest possible edit script D, i.e. the edit information between the regular expression R and the exemplary expression E. If the changes contained in the edit script D are performed in the regular expression R, there is obtained the exemplary expression E.

The invention as such does not require the use of the known Diff algorithm, but it can be replaced by any such reference algorithm that returns the instructions corresponding to the edit script as to how a given target is in the shortest possible way edited in order to give another target as a result. If there are at least two shortest possible ways, from the point of view of the present invention it is not essential which of these ways is chosen. A shortest possible way means that the so-called editing distance, i.e. the number of required changes, is as small as possible when editing the source into the target.

Next, step 206, the editing operations are read one by one from the edit script returned by the Diff reference algorithm. The edit script D and the tokens contained in the regular expression R are compared, step 207. The regular expression R is changed so that those tokens to which the edit information obtained from D refers to are marked with the wildcard symbol, in which case only the unchanged tokens of R are left in their original form. Next it is checked whether all editing operations of D are already applied. If there are editing operations still unread, step 206 is resumed. Again those tokens to which the edit information refers to are marked in the regular expression R with a given wildcard symbol (*−wildcard).

At step 209 it is checked whether there are more exemplary expressions in the example list. All examples in the list are gone through one by one, i.e. if there are more examples, step 204 is resumed. If all exemplary expressions have been treated, we proceed to step 210, and successive wildcard symbols are removed from the created regular expression, so that only the first wildcard symbol of sequential wildcard symbols is left. Next the regular expression R is edited to form part of the data conversion script 211. Originally (before this step) the data conversion script is empty. The data conversion script to be generated searches for character strings in the source data on the basis of the input data. When a regular expression includes a wildcard symbol, the source data is searched for that character string which in the regular expression follows after the wildcard symbol. The wildcard symbol in a way replaces the smallest amount of any characters contained in the source data, as far as that character string that is located in the source data after the wildcard symbol. This interpretation of the wildcard symbol is often called the reluctant interpretation.

In front of the data conversion script, there is further added, according to step 212, a code whereby a data area as a whole is extracted from the source data. In this example, the code generation application deals with the contents of this source data, and the extraction component converts the desired parts thereof to conform to the target format. Thereafter in the data conversionscript there may further be added, according to this example, parameters that are either given by the user or determined in advance, which parameters define the target format. Thus the code generation application generates adata conversion script that extracts from the data areas all such data that matches the given data structure examples for further processing, which in this exemplary case means converting to a uniform target format.

One alternative for automatically creating the data conversion script according to steps 211 and 212 is to proceed from step 210 onwards so that the created regular expression R is stored and treated in some other way than by integrating it as part of the data conversion script. It can for example be reused “manually” as part of some other program product, or it can be applied as an extraction script only, without performing the conversion into the target format.

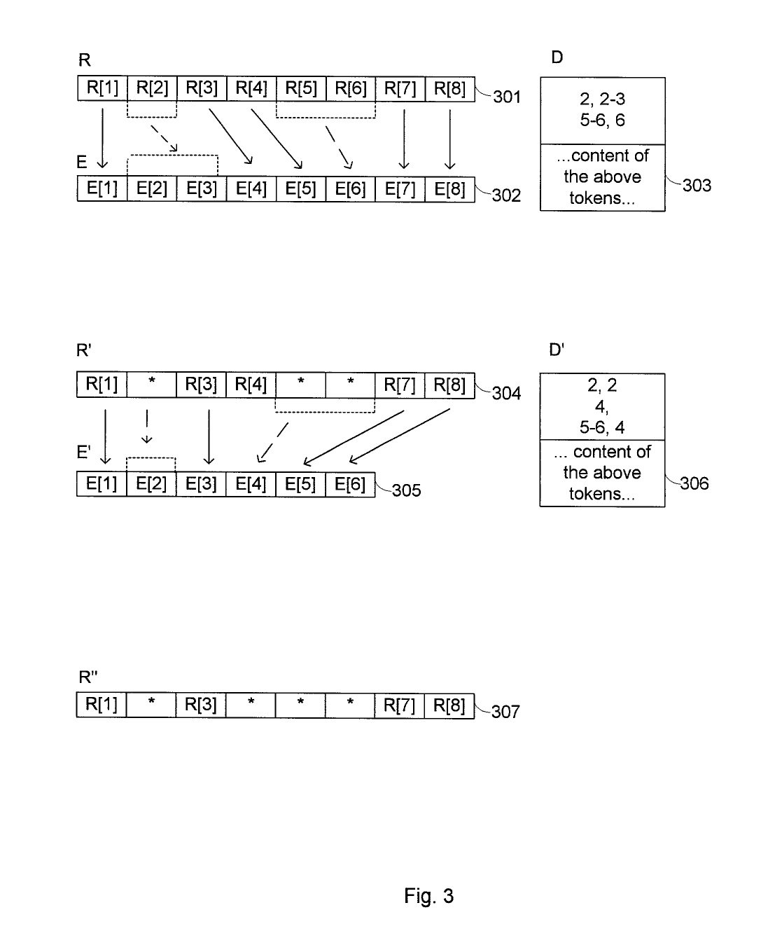

Let us further observe, with reference to FIG. 3, how a regular expression is created. In this exemplary case, the user has pointed out to the code generation application three exemplary expressions, which have been tokenized. The two longest exemplary expressions consist of 8 tokens, and the shortest exemplary expression consists of 6 tokens. As a regular expression R 301, there is marked the longest exemplary expression, i.e. in this case either of the longer expressions having 8 tokens. The other longer expression that is left is marked as E 302. The expressions R and E are pointed as parameters to the known Diff reference algorithm, which returns the edit script D 303. Now the edit information of the edit script is presented so that the first numerals of each row refer to the tokens to be replaced in the regular expression R 301, and the following numerals refer to the tokens to be replaced in the exemplary expression E 302. Moreover, the edit script D 303 includes the contents of those tokens where changes are taking place. According to the edit script D 303 illustrated in FIG. 3, the token R[2] of the regular expression R 301 is changed to conform to the tokens E[2] and E[3] of the exemplary expression E 302. The tokens R[5] and R[6] of the regular expression R 301 must be replaced by the token E[6] of the exemplary expression E 302. In the drawing, all changing tokens are illustrated by an arrow with a dotted line, and all constant, mutually corresponding tokens are illustrated by an arrow with a continuous line.

Next there is created a new regular expression R′ 304, so that the unchanged tokens remain intact in the regular expression R 301, and all tokens, marked with the dotted line arrow, that deviate from the exemplary expression E 302 and are changed according to the edit information of the edit script, are marked with a wildcard symbol, which in this example is *. As the new exemplary expression E′ 305, there is marked the next example fed in by the user, whereafter there is generated the edit information D′ 306 between R′ 304 and E′ 305 by means of the Diff reference algorithm. The changes read from the edit script D′ 306 returned by the Diff reference algorithm are marked with dotted line arrows, and the unchanged tokens of R′ 304 and E′ 305 are connected with continuous line arrows. Moreover, the second edit information of the edit script refers to the token R[4] that has no counterpart in the exemplary expression E′ 305. Now the token R[4] is replaced by empty, and when creating the next regular expression, it is treated in the same way as other replaceable tokens. In the created regular expression R″ 307, there are left the unchanged tokens R[1], R[3], R[7] and R[8]. All changed tokens are replaced by the chosen wildcard symbol *. Thereafter successive wildcard symbols (not illustrated) are removed from the regular expression R″ 307, so that only the first wildcard symbol of sequential wildcard symbols is left. In the exemplary expression R″ 307, there are now four field separator tokens, in between which there are created two separate fields. The first field containing data proper is located between the tokens R[1] and R[3], and the second field is located between the tokens R[3] and R[7]. The field separators R[7] and R[8] are placed in succession and form the end mark of this regular expression. Now the regular expression R″ 307 is ready and can be added for instance as part of the extraction script.

In case one of the exemplary expressions has no structure at all, the above described procedure results in a case where the regular expression R″ finally is just one wildcard symbol. Now the created data conversion script extracts the whole data area where the extraction rules are attempted to apply. As a result of the extraction, all of the extracted data is located in one field of one record of the extracted data area.

The code generation component (102) of the code generation application generates a code-language extraction script, on the basis of which the extraction component proper performs selective data extraction from the incoming data. Advantageously the extraction script is generated in a known code language, depending on the application in question. Advantageously the code generation application functions in all versions of Java 1.2.2, or more recent versions. As a result, there is obtained the extracted data in the format and order defined by the code-language script. The DEL (Data Extraction Language) that was mentioned by way of example above is written only and especially for data extraction, but it does not in any way restrict the invention to the use of only this one language; there can advantageously be used for instance the following processors: Perl, Python, REBOL and OmniMark. The language works in the same way as the format converter, i.e. it does not extract for instance the subject of an expression, but it operates on the symbol level. For editing extraction rules based on regular expressions, there is a specific editor that depends on the component used for extraction in each case. The data field to be extracted is a character string that can, by modifying the script, be set to be transferred to a given location of the result data generated by the extraction component (104) of the code generation application.

The code generation application can use any browser for displaying data and for making selections from the data. The functional features required of the browser include that the functionality connected to loading (opening/closing a file/data stream), displaying and selecting the data can be controlled and adjusted through some kind of programming interface, and that all data regarding the choices of the user is obtained immediately at the disposal of the code generation application. It depends on the employed browser how and to what extent the continuous data stream is displayed to the user. It is also possible to use several browsers simultaneously, so that for instance the source data to be processed in each case is located in a specific browser, the chosen examples are stored in another browser and the preview of the results of the data extraction takes place in a third browser.

The generation of the data extraction rules and the extraction and the conversion of the data into a desired target format can, when desired, be realized as a service over the network. In that case each code generation component, extraction component or both can be located at the server, while the rest of the application resides at the user's workstation.

Consequently, as the result of executing the application, there is obtained a data packet with a desired content. The user does not have to be able to program or to edit the application but he obtains the results according to his examples from any chosen source data. The obtained information can be further refined, applied in statistics and published simultaneously in many different formats by using external software applications. The application according to the invention is effective and versatile. It is easily transferred and maintained in current hardware arrangements, because the Java-based DEL processor used in a preferred embodiment is easily integrated in many different systems. Advantageously the user interface of the application functions for example in the Windows 2000/NT environment provided with a Microsoft Internet Explorer browser, version 5 or some more recent solution. Moreover, the code generation application is flexible and can easily be adapted to a completely new type of source data, too.

1. A method for processing information contained in a body of given original data, the method comprising the steps of:
pointing out at least two exemplary cases,
comparing the at least two exemplary cases to each other for finding congruent parts from them,
as a result of the comparing, generating a regular expression, which describes the appearance of congruent parts in the at least two exemplary cases,
on the basis of the generated regular expression, generating a set of rules for extracting data of a desired kind, and
extracting data areas from the original data according to the generated set of rules.

2. A method according to claim 1, comprising the step of modifying the extracted data areas to be uniform in format.

3. A method according to claim 1, wherein the at least two exemplary cases that are pointed out each have a structure and a content, and the structure of the exemplary cases is identical, but the content is different.

4. A method according to claim 1, wherein the exemplary cases are pointed out from the original data.

5. A method according to claim 1, wherein the regular expression comprises the congruent parts and wildcard expressions, which correspond to matter to be extracted.

6. A method according to claim 1, wherein the set of rules generated on the basis of the regular expression is stored for further usage.

7. A method according to claim 1, comprising the step of tokenizing the chosen exemplary cases prior to the processing proper thereof, by replacing certain elements of the exemplary cases by corresponding data structures, which contain an identifier, such as a type characteristic, or a name, as well as a data content of said element.

8. A method according to claim 7, wherein between the at least two exemplary cases pointed out, there is at least one identical element, the counterpart whereof in the treatment of the exemplary cases is a given token.

9. A method according to claim 7, wherein in order to generate a set of rules, the method comprises the steps of:
marking the longest of the selected, tokenized examples as a regular expression,
marking the next longest of the selected, tokenized examples as an exemplary expression and
comparing the regular expression with the exemplary expression of the moment in question.

10. A method according to claim 9, wherein the regular expression and the exemplary expression of the moment in question are compared by means of a given reference algorithm that returns an edit script.

11. A method according to claim 10, wherein the regular expression and the exemplary expression of the moment are compared by means of a reference algorithm that returns the shortest possible edit script.

12. A method according to claim 10, wherein in order to generate a set of rules, the regular expression is modified according to the edit information contained in the edit script.

13. A method according to claim 9, wherein the created regular expression constitutes a set of rules by itself.

14. A method according to claim 1, wherein by means of the generated set of rules, from the original data there are extracted elements according to the exemplary cases.

15. An arrangement for processing information contained in a given original data, comprising:
means for pointing out at least two exemplary cases,
means for comparing the at least two exemplary cases to each other for finding congruent parts from them,
means for generating, as a result of the comparing, a regular expression, which describes the appearance of congruent parts in the at least two exemplary cases,
means for generating a set of rules on the basis of the generated regular expression, in order to extract desired information, and
means for extracting data areas from the original data according to the generated rules.

16. An arrangement according to claim 15, comprising means for modifying the extracted elements to be uniform in format.

17. An arrangement according to claim 15, wherein in order to point out exemplary cases, the arrangement is provided with pointers to character strings.

18. An arrangement according to claim 15, comprising means for tokenizing the examples pointed out by replacing given elements of the exemplary cases by corresponding data structures that contain a type characteristic or a name as well as a data content of said element.

19. An arrangement according to claim 18, wherein the arrangement includes means for processing tokenized data.

20. An arrangement according to claim 15, wherein the arrangement includes means for generating a set of rules according to a created regular expression.

21. An arrangement according to claim 15, wherein the means for generating the set of rules including a program component created especially for this purpose, which program component is different from the program component that is meant for extracting data areas by using the generated set of rules.

22. A computer program element comprising: computer program code means to make the computer execute a procedure that comprises the steps of:
pointing out at least two exemplary cases,
comparing the at least two exemplary cases to each other for finding congruent parts from them,
as a result of the comparing, generating a regular expression, which describes the appearance of congruent parts in the at least two exemplary cases,
on the basis of the generated regular expression, generating a set of rules for extracting data of a desired kind, and
extracting data areas from the original data according to the generated set of rules.

23. A computer readable medium, having a program recorded thereon, where the program is to make the computer execute a procedure that comprises the steps of:
pointing out at least two exemplary cases,
comparing the at least two exemplary cases to each other for finding congruent parts from them,
as a result of the comparing, generating a regular expression, which describes the appearance of congruent parts in the at least two exemplary cases,
on the basis of the generated regular expression, generating a set of rules for extracting data of a desired kind, and
extracting data areas from the original data according to the generated set of rules.

24. A computer program product stored on a computer usable medium, comprising: computer readable program means for causing a computer to execute a procedure that comprises the steps of:
pointing out at least two exemplary cases,
comparing the at least two exemplary cases to each other for finding congruent parts from them,
as a result of the comparing, generating a regular expression, which describes the appearance of congruent parts in the at least two exemplary cases,
on the basis of the generated regular expression, generating a set of rules for extracting data of a desired kind, and
extracting data areas from the original data according to the generated set of rules.
